(19) United States
(12) Patent Application Publication
(10) Pub. No.: US 2007/0182664 A1
(43) Pub. Date: Aug. 9, 2007

(54) Head-worn assembly with removable display

(76) Inventor: Tristram Himmele, Palm Beach, FL (US)

Correspondence Address: Clifford Kraft, 320 Robin Hill Dr., Naperville, IL, 60540, US

(21) Appl. No.: 11/350,600

(22) Filed: Feb. 9, 2006

(51) Int. Cl. G09G 5/00

(52) U.S. Cl. 345/8

(57) ABSTRACT

A helmet or headgear assembly that includes a fixed or removable display that can display any message desired by the user and a set of fixed or removable accessories including a radio, earphone(s), microphone, earmuffs and camera. The display can be an LED display and can optionally scroll horizontally, vertically or both. All of the elements of the invention can be removed from the helmet or headgear and used in any combination.

### BACKGROUND

1. Field of the Invention

The present invention relates generally to event accessories, particularly sporting events, and more particularly to an assembly, that can include display mounted on a helmet or other piece of head gear, a fixed or removable radio with optional microphone, fixed or removable earmuffs and a fixed or removable camera.

2. Description of the Prior Art

It is often desirable to wear a helmet or other headgear at a sporting event to express support for one's team or to wear a helmet or headgear to signify a particular position (such as a construction helmet of a particular color to signify a foreman, engineer, welder, etc.).

It would be advantageous to have a mechanism to be able to display a message for others to see from the helmet or headgear. At a sporting event, it would be very desirable to have a piece of headgear that could contain a display where the user could display a team name, advertisement or other message. It would also be advantageous to have fixed or removable accessories such as a radio, earphones, camera, microphone that could be added and used as desired. These accessories could be particularly useful and desirable at a sporting event.

### SUMMARY OF THE INVENTION

The present invention relates to a work or sports accessory that includes a headgear unit worn on a user's head with a display attached to an outside surface of the headgear unit with the display displaying an image that is visible to another person. In addition, the present invention includes a set of fixed or removable accessories that can be attached to the headgear such as a radio, earphone, microphone, camera and earmuffs. The invention can be used at sporting or other events and can be used on various jobs such as construction work.

In using the present invention, a user takes the helmet, or other headgear or head support system and decides whether or not to add accessories. For example, the user can decide to add, or not to add, a display board, camera, radio or earmuffs. The system of the present invention is completely usable no matter what combination of accessories are added.

### BRIEF DESCRIPTION OF THE DRAWINGS

The following illustrations show aspects and embodiments of the present invention.

FIG. 1A shows a perspective view of an embodiment of the present invention with a helmet and a display.

FIG. 1B shows a side view of the embodiment of FIG. 1A.

FIG. 2A shows a perspective view of the embodiment of FIG. 1A with a removable optical element added.

FIG. 2B shows a side view of the embodiment of FIG. 5A.

FIG. 3A shows the a perspective view of the embodiment of FIG. 1A with a removable radio added.

FIG. 3B shows a side view of the embodiment of FIG. 3A.

FIG. 4A shows a perspective view of the embodiment of FIG. 1A with removable earmuffs added.

FIG. 4B shows a side view of the embodiment of FIG. 4A.

Several illustrations and drawings have been presented to better aid in the understanding of the present invention. The scope of the present invention is not limited to what is shown in the figures.

### DETAILED DESCRIPTION OF THE INVENTION

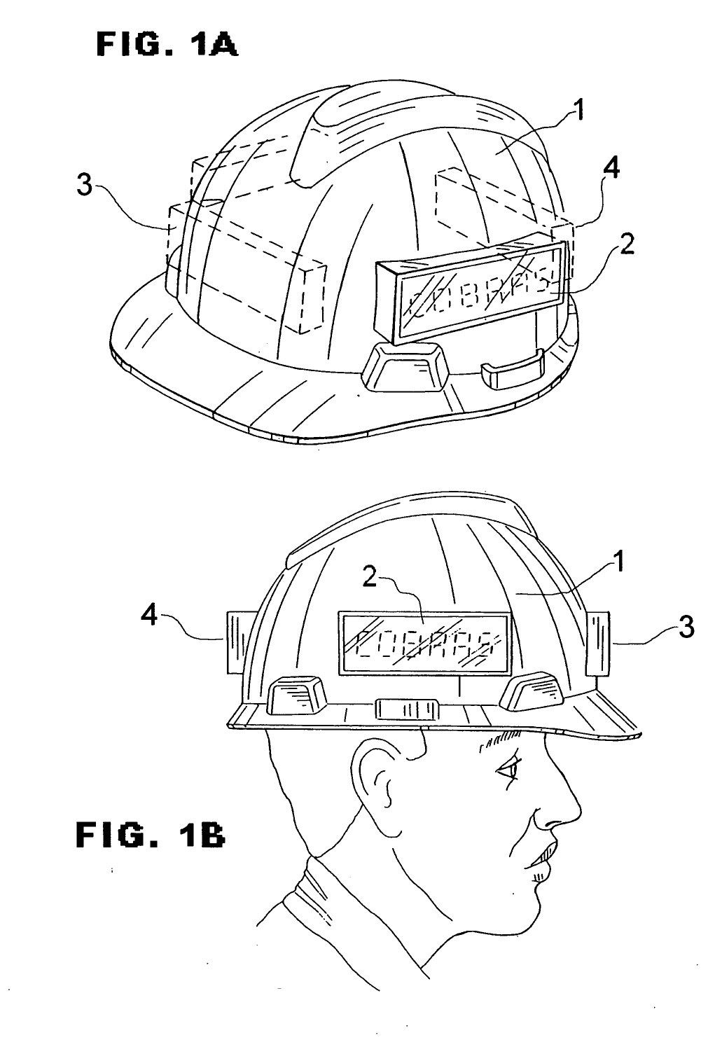

Turning to FIGS. 1A and 1B, a helmet or headgear device 1 can be seen. This can be a helmet or hardhat similar to those used on construction sites, or it can be any other type of headgear or head mounted device. The helmet, hardhat or headgear 1 can be equipped with a fixed or removable active display or signboard 2 that can be side mounted 2, front mounted 3 or rear mounted 4. The display 2 can be an electronic LED or other electronic device and can be programmable by the wearer to display any message desired. Typical messages include a team name or slogan (such as GO COBRAS) for a sporting event, a title (like INSPECTOR or LINE FORMAN) for a construction site or advertising (like DRINK T-BEER). The display can optionally scroll sideways or from top to bottom. The display can contain batteries or optionally be solar powered (or both). Numerous displays are known in the art. The preferred type is an LED display. Any type or shape of display is within the scope of the present invention. The preferred display is a rectangular electronic LED display that is bright enough to be seen in the sun and can be programmed to display any banner or message the user desires. The display can generally be used to communicate visually with other people in the vicinity of the wearer (such as other even-attendees). The display can optionally be able to scroll vertically and/or horizontally. An embodiment of the display can scroll though a longer message like a stock ticker.

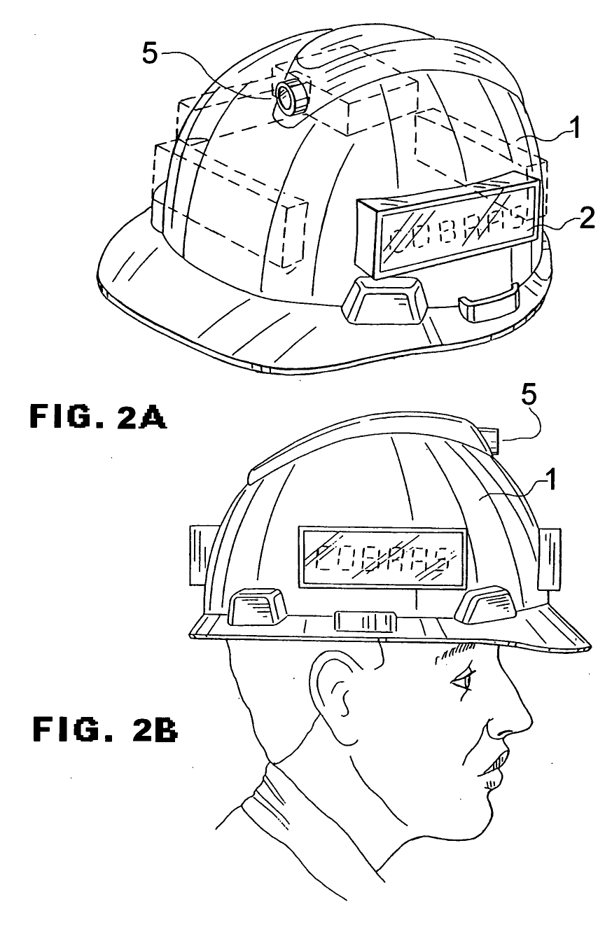

FIGS. 2A and 2B show an embodiment similar to that of FIG. 1A with a fixed or removable camera 5. The camera 5 shown in FIGS. 2A-2B is shown mounted in the center of the helmet or headgear 1; however, it is within the scope of the present invention to mount the camera 5 anywhere. The preferred camera is one with an infinite depth of field so that no focus adjustment is necessary; however any type of camera with any type of lens or iris system can be used. The camera 5 can also be a video camera or camcorder. The camera 5 can be controlled with buttons on the camera or headgear or remotely.

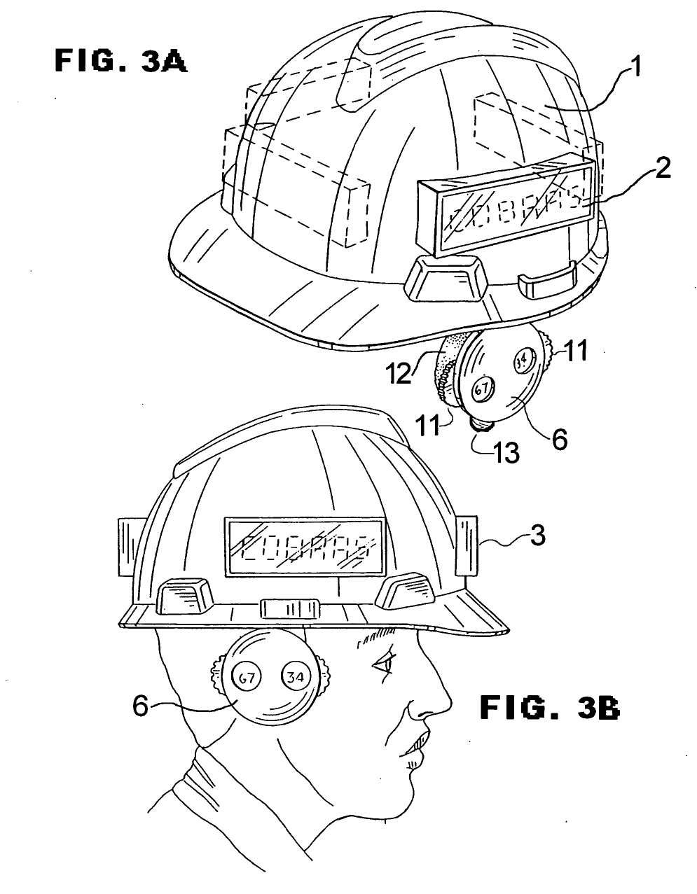

FIGS. 3A and 3B show views of an embodiment of the present invention containing a helmet or other piece of headgear 1 along with fixed or removable earphones 12 that are connected to a fixed or removable radio and/or a digital music device 6. The music device or radio 6 can contain user operated controls 11 and earphones 12 and an optional microphone 13. The radio 6 can be FM, AM, sports channel, TV sound channel, weather channel, scanner or any other type of radio device. It can also contain an optional microphone and/or cellular telephone. The earphone(s) 12 can optionally be noise-canceling and can be used with or without the radio 6. In one embodiment of the invention, the earphone 12 can be used with an optional music device such as a MP3 player. The radio 6 can optionally contain a transmitter that transmit voice or other sound from the microphone 13. While FIGS. 3A-3B show a small microphone attached to the earphone unit, the microphone can be directly attached to the headgear if desired. The microphone can be a boom type or a button type or any other type of microphone. The audio or music device or radio can be located on the user's body away from the headgear and can resemble small popular digital music devices known in the art if desired. In this case, the device could be wired to the earphone on the headgear, or it could communicate wirelessly with the earphone 12 or microphone 13 using a short-range wireless technique such as Bluetooth or any other wireless technique.

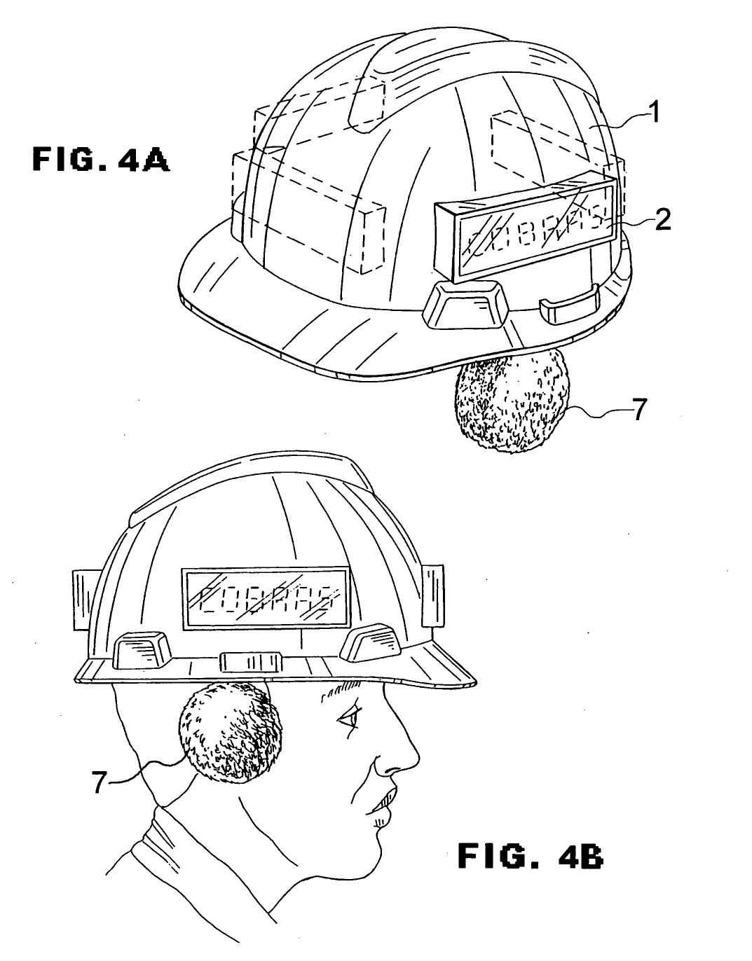

FIGS. 4A-4B show the embodiment of FIGS. 1A-1B with a fixed or removable earmuff 7. The earmuffs 7 shown in FIG. 4A can be attached like the radio or earphone 6 in FIG. 3A or it can use a different attachment method. A slip-out clip or device is the preferred method of mounting the earmuffs 7 or radio/earphone 6. It should be noted that the earmuff 7 can be part of the radio 6 or earphone 12, or it can be totally separate. Because a user will not need earmuffs in the summer or on any warm day, the earmuffs, as all of the equipment on the device, can be removable. Two different types earmuffs can be used with the present invention: those that are simply earmuffs and those that are earmuffs that also combine and earphone. Of course, the present invention also can include a fixed or removable earphone that has no earmuff.

A major feature of the present invention is the user's ability to decide which parts or accessories to use with the headgear. All of the various parts of the present invention including the display, camera, radio/earphone, earmuffs and microphone are generally removable. In this manner, the user can pick and choose which parts he or she will use for that particular day or for a particular event. The choice can be based on the type of event or use and on the user's particular preferences.

The embodiments of the invention described here is of course subject to many different variations in structure, design, application and methodology. Because many varying and different embodiments may be made within the scope of the inventive concepts taught, and because many modifications may be made in the embodiments described, these variations and different embodiments are within the scope of the present invention.

I claim:

1. A work or sports accessory comprising:
a headgear unit worn on a user's head;
a fixed or removable display attached to an outside surface of said headgear unit, said display displaying an image, wherein said image is visible to another;
a fixed or removable earphone attached to said headgear unit, wherein said user can listen to audio.

2. The accessory of claim 1 further comprising a fixed or removable camera attached to said headgear unit.

3. The accessory of claim 1 further comprising a microphone.

4. The accessory of claim 1 further comprising a radio.

5. The accessory of claim 1 wherein said display displays alphanumeric or numeric images.

6. The accessory of claim 1 wherein said display displays advertising.

7. The accessory of claim 1 wherein said display is user—programmable.

8. The accessory of claim 1 wherein said display is an LED display.

9. The accessory of claim 1 wherein said display can scroll.

10. A sports utility system comprising a head support worn on a person's head with a fixed or removable radio attached to the head support and a display also attached to the head support oriented so that another person can see an image on the display.

11. The sports utility system of claim 10 where the display is removable.

12. A method of configuring a sports system of the type with a head support comprising the steps of:
making a decision whether or not to attach a removable display to said head support;
attending an event using said display to display an image viewable by others.

16. The method of claim 15 further comprising making a decision whether or not to attach a removable radio to said head support.

17. The method of claim 15 further comprising making a decision whether or not to attach removable earmuffs to said head support.

18. The method of claim 15 further comprising making a decision whether or not to attach a removable camera to said head support.

19. The method of claim 15 wherein said display is an LED display.

20. The method of claim 15 wherein said display can scroll.
